(19) United States
(12) Patent Application Publication
(10) Pub. No.: US 2025/0155772 A1
(43) Pub. Date: May 15, 2025

(54) LASER PROCESSING DEVICE, CONTROL METHOD, AND PROGRAM

(71) Applicant: Panasonic Holdings Corporation, Osaka (JP)

(72) Inventor: SHINICHI OKADA, Osaka (JP)

(21) Appl. No.: 19/019,597

(22) Filed: Jan. 14, 2025

Related U.S. Application Data
(63) Continuation of application No. PCT/JP2023/022657, filed on Jun. 19, 2023.

(30) Foreign Application Priority Data
Jul. 27, 2022 (JP) 2022-119569

(51) Int. Cl. G02F 1/29; B23K 26/0622

(52) U.S. Cl. CPC G02F 1/29; B23K 26/0622

(57) ABSTRACT

A laser processing device includes a laser oscillator that oscillates pulse laser light; a power source that supplies power to the laser oscillator; an optical modulator that switches an emission direction of the pulse laser light to either a first direction toward a target object or a second direction not toward the target object; and a controller that generates a first control signal and a second control signal, the first control signal being a signal for controlling supply of the power by the power source to generate at least one set of a power supply period and a power non-supply period, the second control signal being a signal for controlling change of the emission direction by the optical modulator to cause the power supply period to include a plurality of first periods in which the emission direction is the first direction.

### TECHNICAL FIELD

The present disclosure relates to a laser processing device, a control method of the laser processing device, and a program.

### BACKGROUND ART

Conventionally, a method of processing (welding, cutting, drilling, etc.) a metal using pulsed laser light is known. For example, Patent Literature 1 discloses a laser processing device in which laser light beams of a plurality of sub-pulse trains having different pulse waveforms are combined.

In Patent Literature 1, the laser processing device sequentially irradiates an object to be processed with the laser light of the first sub-pulse train, the laser light of the second sub-pulse train, and the laser light of the third sub-pulse train to perform high-quality processing. The first sub-pulse train includes a high peak output and a small number of pulses. The laser light of the first sub-pulse train starts melting while resisting the surface reflection loss of the object to be processed at the start of drilling. The second sub-pulse train includes pulses having a lower peak output than the first sub-pulse train and a greater number of pulses than the first sub-pulse train. The laser light of the second sub-pulse train melts and evaporates the metal member in the deep portion of the drilled portion being formed to advance drilling in the depth direction. The third sub-pulse train includes pulses having a peak output different from those of the first and second sub-pulse trains and a number of pulses different from those of the first and second sub-pulse trains. The laser light of the third sub-pulse train generates metal vapors having different scattering distances in the drilled portion being formed.

### CITATION LIST

### Patent Literature

PTL 1: Unexamined Japanese Patent Publication No. 2016-168606

### SUMMARY OF THE INVENTION

A laser processing device according to one aspect of the present disclosure includes: a laser oscillator that oscillates pulse laser light; a power source that supplies power to the laser oscillator; an optical modulator that switches an emission direction of the pulse laser light to either a first direction toward a target object or a second direction not toward the target object; and a controller that generates a first control signal and a second control signal, the first control signal being a signal for controlling supply of the power by the power source to generate at least one set of a power supply period and a power non-supply period, the second control signal being a signal for controlling change of the emission direction by the optical modulator to the power supply period to include a plurality of first periods in which the emission direction is the first direction.

A control method of a laser processing device according to one aspect of the present disclosure is a control method of a laser processing device that includes: a power source that supplies power to a laser oscillator that oscillates pulse laser light; an optical modulator that switches an emission direction of the pulse laser light to either a first direction toward a target object or a second direction not toward the target object; and a controller that generates a control signal for the power source and the optical modulator, the control method including: generating, by the controller, a first control signal for controlling supply of the power to generate at least one set of a power supply period and a power non-supply period, and outputting the first control signal to the power source; and generating, by the controller, a second control signal for controlling change of the emission direction to cause the power supply period to include a plurality of first periods in which the emission direction is the first direction, and outputting the second control signal to the optical modulator.

A program according to one aspect of the present disclosure is a program executed by a computer of a laser processing device that includes: a power source that supplies power to a laser oscillator that oscillates pulse laser light; an optical modulator that switches an emission direction of the pulse laser light to either a first direction toward a target object or a second direction not toward the target object; and a controller that generates a control signal for the power source and the optical modulator, the program causing the computer to execute procedures of: generating a first control signal for controlling supply of the power to generate at least one set of a power supply period and a power non-supply period, and outputting the first control signal to the power source; and generating a second control signal for controlling change of the emission direction to cause the power supply period to include a plurality of first periods in which the emission direction is the first direction, and outputting the second control signal to the optical modulator.

A laser processing device according to one aspect of the present disclosure includes: a laser oscillator that emits pulse laser light; an optical modulator that irradiates a target object with a pulse laser group including a plurality of sub-pulse light beams shorter than one pulse of the pulse laser light by switching an emission direction of the pulse laser light; and a controller that controls outputting of the pulse laser light by the laser oscillator and switching of the emission direction by the optical modulator.

### BRIEF DESCRIPTION OF THE DRAWINGS

FIG. 1 is a block configuration diagram schematically illustrating a laser processing device according to a first exemplary embodiment of the present disclosure.

FIG. 2 is a diagram schematically illustrating a temporal configuration of an output signal in each unit of the laser processing device.

FIG. 3A is a diagram for explaining a data structure related to time information.

FIG. 3B is a diagram for explaining a data structure related to time information.

FIG. 3C is a diagram for explaining a data structure related to time information.

FIG. 3D is a diagram for explaining a data structure related to time information.

FIG. 4A is a diagram for explaining a data structure related to electrical information.

FIG. 4B is a diagram for explaining a data structure related to electrical information.

FIG. 4C is a diagram for explaining a data structure related to electrical information.

FIG. 4D is a diagram for explaining a data structure related to electrical information.

FIG. 5 is a block configuration diagram schematically illustrating a laser processing device according to a second exemplary embodiment of the present disclosure.

FIG. 6A is a diagram illustrating an example of a data structure related to position information.

FIG. 6B is a diagram illustrating an example of a data structure related to position information.

FIG. 7 is a block configuration diagram schematically illustrating a laser processing device according to a first modification.

FIG. 8 is a diagram illustrating an example of a data structure holding position information and time information used in a laser processing device according to the first modification.

FIG. 9 is a block configuration diagram schematically illustrating a laser processing device according to a second modification.

### DESCRIPTION OF EMBODIMENTS

In general, a laser processing device requires large power to generate laser light. Therefore, in the laser processing device, it is desired to achieve both high-quality processing and reduction in power consumption.

An object of the present disclosure is to provide a laser processing device, a control method, and a program capable of achieving both high-quality processing and reduction in power consumption.

Exemplary embodiments of the present disclosure will be described below with reference to the drawings.

### First Exemplary Embodiment

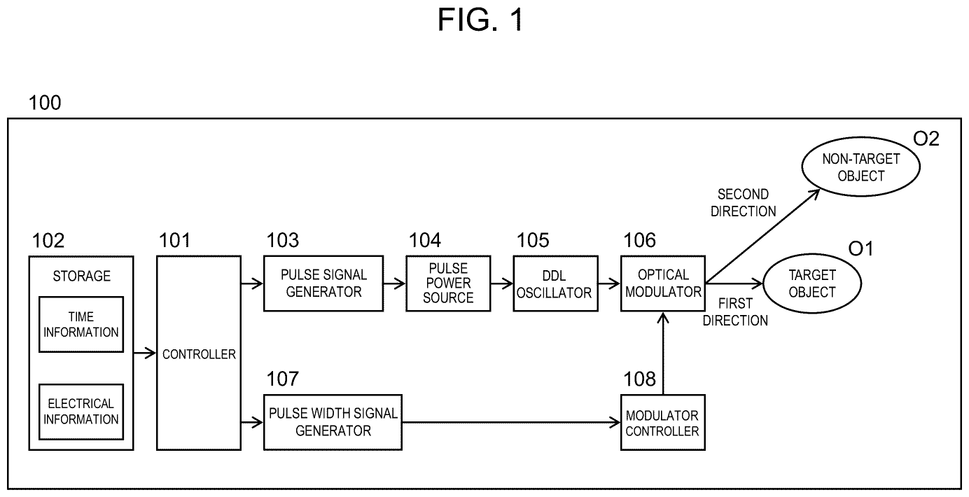

FIG. 1 is a block configuration diagram schematically illustrating laser processing device 100 according to a first exemplary embodiment of the present disclosure. Laser processing device 100 is a device that processes (welds, cuts, drills) target object O1 using laser light. Laser processing device 100 includes controller 101, storage 102, pulse signal generator 103, pulse power source 104, direct diode laser (DDL) oscillator 105, optical modulator 106, pulse width signal generator 107, and modulator controller 108.

Controller 101 generates a control signal for controlling entire laser processing device 100 on the basis of information stored in storage 102. Controller 101 is a processor that performs overall control of laser processing device 100 by reading and executing a program stored in storage 102. Storage 102 is a computer-readable recording medium that stores various kinds of information for generating a control signal, a program, and the like.

Controller 101 outputs a first control signal to pulse signal generator 103 and outputs a second control signal to pulse width signal generator 107. Details of the first control signal and the second control signal will be described later.

Pulse signal generator 103 generates a series of pulse signals (hereinafter, also referred to as a pulse signal train) for pulse power source 104 to control power supply to DDL oscillator 105 on the basis of the first control signal.

Pulse power source 104 supplies power (current or voltage) to DDL oscillator 105 on the basis of the pulse signal train. DDL oscillator 105 supplied with power from pulse power source 104 converts the supplied power into optical energy to generate laser light. In the present exemplary embodiment, a direct diode laser (DDL) capable of generating high-output laser light is adopted as the configuration for generating laser light. However, the present disclosure is not limited to this, and other types of laser generators may be adopted.

The emission direction of the laser light generated by DDL oscillator 105 is switched by optical modulator 106 to either target object O1 that is the object to be processed by laser processing device 100 or non-target object O2 that is not the object to be processed. In the present disclosure, a direction toward target object O1 is defined as a first direction, and a direction not toward target object O1 is defined as a second direction. The direction toward non-target object O2 is an example of the second direction.

As optical modulator 106, for example, an acousto optics modulator (AOM), an electro optics modulator (EOM), an electro-absorption (EA) optical modulator, or the like can be adopted. The AOM generates a diffraction grating by ultrasonic waves inside an element and polarizes input laser light. The EOM polarizes the laser light input by the Pockels effect of LiNbO₃. The EA optical modulator polarizes laser light using an electrolytic absorption effect of a semiconductor.

Pulse width signal generator 107 generates a series of pulse width signals (hereinafter, also referred to as a pulse width signal train) for controlling switching of the emission direction of the laser light by optical modulator 106 on the basis of the second control signal.

Modulator controller 108 controls switching of the emission direction of the laser light by optical modulator 106 based on the pulse width signal train.

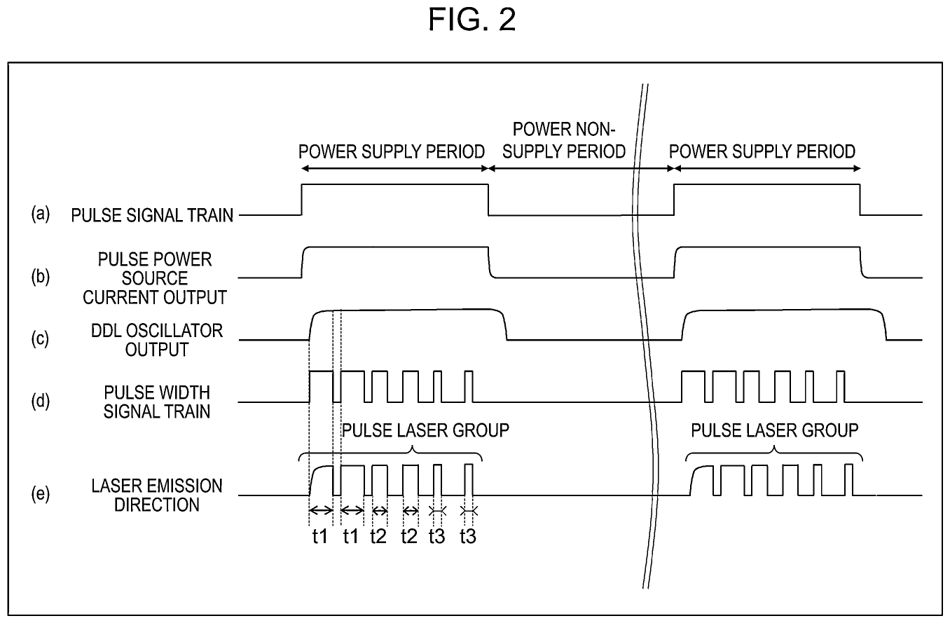

FIG. 2 is a diagram schematically illustrating a temporal configuration of an output signal in each unit of laser processing device 100. Part (a) of FIG. 2 illustrates a pulse signal train output from pulse signal generator 103 based on the first control signal supplied from controller 101. Part (b) of FIG. 2 illustrates power (current in this case) output from pulse power source 104 based on the pulse signal train illustrated in part (a) of FIG. 2. Part (c) of FIG. 2 illustrates the optical energy output of the laser light generated by DDL oscillator 105 based on the current output illustrated in part (b) of FIG. 2.

Part (d) of FIG. 2 illustrates a pulse width signal train output from pulse width signal generator 107 based on the second control signal supplied from controller 101. Part (e) of FIG. 2 illustrates the optical energy output of the laser light emitted in the first direction (the direction toward target object O1 to be processed) by optical modulator 106 while switching the emission direction of the laser light having the optical energy illustrated in part (c) of FIG. 2 based on the pulse width signal train illustrated in part (d) of FIG. 2.

The signal period of the pulse signal train illustrated in part (a) of FIG. 2 is, for example, a unit of millisecond or microsecond. The output current from pulse power source 104 illustrated in part (b) of FIG. 2 shows a rounded rise as compared with the pulse signal train illustrated in part (a) of FIG. 2 due to the influence of the impedance including the laser diode in DDL oscillator 105 serving as the load. When the current supplied from pulse power source 104 exceeds a threshold, the laser diode in DDL oscillator 105 starts light emission, and a pulsed optical energy output is generated from DDL oscillator 105 (see part (c) of FIG. 2).

As illustrated in part (a) of FIG. 2, the pulse signal train generated by the pulse signal generator 103 on the basis of the first control signal includes a power supply period in which power is supplied from pulse power source 104 to DDL oscillator 105 and a power non-supply period in which power is not supplied. The power supply period is a period in which the pulse signal train is at a high level, and the power non-supply period is a period in which the pulse signal train is at a low level. The power supply period and the power non-supply period may be alternately set, for example. In the example illustrated in FIG. 2, the length of the power supply period and the length of the power non-supply period are set to be substantially the same, for example.

As illustrated in part (a) of FIG. 2 and part (b) of FIG. 2, pulse power source 104 supplies power to DDL oscillator 105 in the power supply period in which the pulse signal train is at the high level, and does not supply power to DDL oscillator 105 in the power non-supply period in which the pulse signal train is at the low level. As a result, as illustrated in part (c) of FIG. 2, DDL oscillator 105 generates the laser light in the power supply period and does not generate the laser light in the power non-supply period. As illustrated in part (c) of FIG. 2, the amplitude of the laser light oscillated by DDL oscillator 105 in the power supply period is substantially constant.

As described above, in laser processing device 100, the pulse laser light having a constant amplitude is generated by turning on or off the power supply to DDL oscillator 105 by pulse power source 104 on the basis of the first control signal. As a result, since pulse power source 104 does not supply power to DDL oscillator 105 in the power non-supply period, the power consumption can be greatly reduced as compared with the case where the power source constantly supplies power to the laser oscillator. In the example illustrated in FIG. 2, the power consumption is about half as compared with a case where the power source constantly supplies power to the laser oscillator.

On the other hand, the pulse width signal train illustrated in part (d) of FIG. 2 is a signal for switching the emission direction of the laser light by optical modulator 106, and has a signal period in units of microseconds or nanoseconds, for example. Optical modulator 106 polarizes the laser light from DDL oscillator 105 on the basis of the pulse width signal train illustrated in part (d) of FIG. 2, thereby switching the emission direction of the laser light as illustrated in part (e) of FIG. 2.

As illustrated in part (d) of FIG. 2 and part (e) of FIG. 2, optical modulator 106 switches the emission direction of the laser light to the first direction, that is, the direction toward target object O1 in a period in which the pulse width signal train is at a high level, and switches the emission direction of the laser light to the second direction, for example, the direction toward non-target object O2 in a period in which the pulse width signal train is at a low level. Non-target object O2 is, for example, a beam damper that absorbs laser light, converts the laser light into thermal energy, and diverges the thermal energy. Note that optical modulator 106 including an AOM, EOM, EA optical modulator, or the like can switch the polarization direction of the input optical energy at a very high speed due to its characteristics. Therefore, optical modulator 106 can switch the emission direction of the laser light between the first direction and the second direction at a very high speed. In the following description, a period during which the emission direction of the laser light is the first direction is referred to as a first period.

By such an operation of optical modulator 106, it is possible to obtain a pulse laser group provided with a plurality of first periods in which target object O1 is irradiated with the laser light in one power supply period. Here, in laser processing device 100, the amplitude of the laser light oscillated by DDL oscillator 105 is a constant value, but the amount of optical energy applied to target object O1 is controlled by changing the length of the first period which is a period in which target object O1 is irradiated with the laser light. That is, the length of the first period is adjusted in order to give target object O1 an optical energy amount necessary for processing target object O1.

As illustrated in part (e) of FIG. 2, one power supply period includes a plurality of first periods. The plurality of first periods including one power supply period have a plurality of temporal lengths. In the example illustrated in part (e) of FIG. 2, one power supply period includes six first periods having three temporal lengths. The three temporal lengths (time widths) are t1, t2, and t3 in descending order (t1>t2>t3). In the example illustrated in part (e) of FIG. 2, two first periods each having time width t1, two first periods each having time width t2, and two first periods each having time width t3 are included in the power supply period, and are arranged in the order of longer time widths.

In part (e) of FIG. 2, the reason why the plurality of first periods each having the plurality of time widths are arranged in descending order of time is as follows.

In the laser processing process, it is necessary to melt the processing portion of target object O1 immediately after the processing start. Therefore, in consideration of loss of the laser light due to surface reflection of target object O1, the amount of optical energy applied to the processing portion is set to be larger than the amount of energy required for melting. In the example illustrated in part (e) of FIG. 2, the first period of time t1 having the longest time width is arranged at the beginning of the power supply period corresponding to immediately after the processing start.

After the processing portion is melted, the amount of optical energy is reduced to suppress unnecessary sputtering and bead defects, thereby improving processing quality. In the example illustrated in part (e) of FIG. 2, the first period of time width t2 corresponds to this. Furthermore, at the end of processing, the amount of optical energy applied to the processing portion is further reduced to facilitate cooling. In the example illustrated in part (e) of FIG. 2, the first period of the time width t3 corresponds to this.

Note that the time width of the first period illustrated in part (e) of FIG. 2 is an example for implementing the above-described laser processing process, and the present disclosure is not limited thereto. In order to perform desired processing, the time width of each of the plurality of first periods in one power supply period may be set to an appropriate length. In addition, in the example illustrated in part (e) of FIG. 2, the time width of the first period is three types of t1 to t3, but may be two types or more than four types. In addition, in the example illustrated in part (e) of FIG. 2, two first periods having the same time width are arranged in one power supply period, but the time widths of all the first periods may be different from each other, or three or four first periods having the same time width may be arranged, for example. The time width, the number, and the like of the first period can be arbitrarily set according to the material of target object O1 to be processed and the required processing quality.

Next, the operation of controller 101 will be described. Controller 101 generates a first control signal to be supplied to pulse signal generator 103 and a second control signal to be supplied to pulse width signal generator 107 on the basis of the time information and the electrical information stored in storage 102.

Note that the time information and the electrical information stored in storage 102 are information input in advance by an operator or the like of laser processing device 100 based on the design of processing on target object O1.

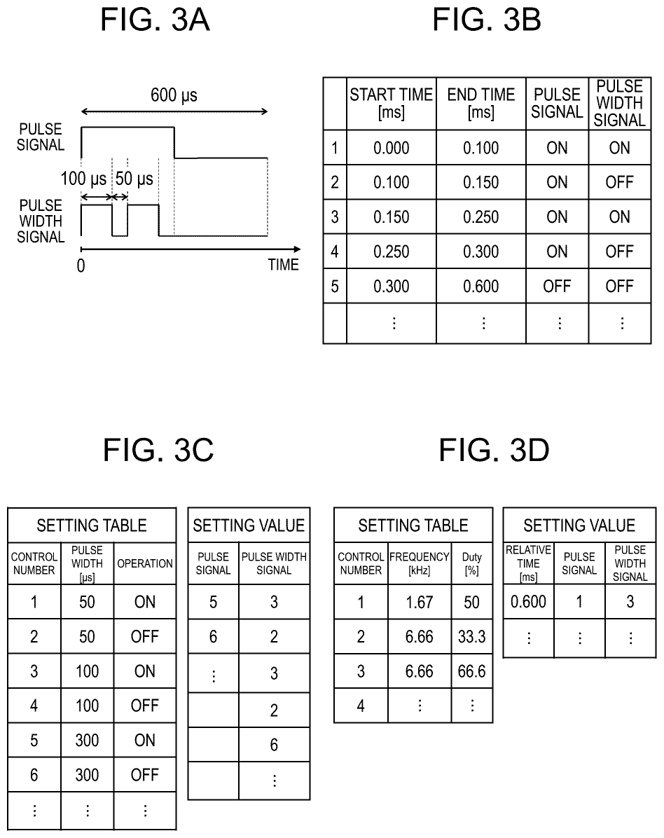

FIGS. 3A to 3D are diagrams for describing a data structure related to time information. The time information is information for designating the ON time and the OFF time of the pulse signal train generated by pulse signal generator 103 and the pulse width signal train generated by pulse width signal generator 107. FIG. 3A illustrates an example of waveforms of a pulse signal train and a pulse width signal train. Time 0 in FIG. 3A is the processing start time. FIGS. 3B, 3C, and 3D illustrate an example of a data structure for generating a pulse signal train and a pulse width signal train of the waveform shown in FIG. 3A.

FIG. 3B illustrates an example of a data structure in which the start time and the end time of the pulse signal and the pulse width signal included in the pulse signal train and the pulse width signal train are indicated in absolute time. FIG. 3C illustrates an example of a data structure in which the time width of one pulse signal or pulse width signal is designated as a relative time by the setting table and the setting value. The setting table indicates the time width and the operation of one pulse signal or pulse width signal in association with the control number, and the setting value indicates the operation of the pulse signal or pulse width signal from the processing start time by the control number in order from the top. FIG. 3D shows an example of a data structure in which the frequency and duty ratio of a pulse specifies the time width and operation of one pulse signal or pulse width signal.

In the data structure illustrated in FIG. 3B, since the start time and the end time are specified by the absolute time, processing can be controlled while synchronizing the pulse signal and the pulse width signal, and time information can be easily designed. However, when the processing time becomes long and the processing becomes complicated, the amount of information increases. In the data structure shown in FIG. 3C and FIG. 3D, when the repetition of the pulse signal or the pulse width signal of the same time width is large, the amount of information can be compressed compared with the data structure of the entire time shown in FIG. 3B.

Based on the time information, controller 101 outputs information indicating the generation time of the pulse signal to pulse signal generator 103 as a part of the first control signal. As a specific example, controller 101 outputs, as a part of the first control signal, information including the left three columns of FIG. 3B showing the correspondence relationship between the absolute time and the ON/OFF of the pulse signal, the left side of the setting value shown in FIG. 3C (information indicating the control number corresponding to the time width of the pulse signal), or information including the left two columns of the setting value shown in FIG. 3D (information indicating the correspondence relationship between the relative time and the control number corresponding to the frequency of the pulse signal) to pulse signal generator 103.

On the other hand, based on the time information, controller 101 outputs information indicating the generation time of the pulse width signal to pulse width signal generator 107 as the second control signal. As a specific example, controller 101 outputs, to pulse signal generator 103, information including two left columns and one right column in FIG. 3B indicating the correspondence relationship between the absolute time and the ON/OFF of the pulse width signal, or information indicating the correspondence relationship between the relative time and the control number corresponding to the frequency of the pulse width signal of the right side of the setting value illustrated in FIG. 3C (information indicating the control number corresponding to the time width of the pulse width signal), or the setting value illustrated in FIG. 3D, as the second control signal.

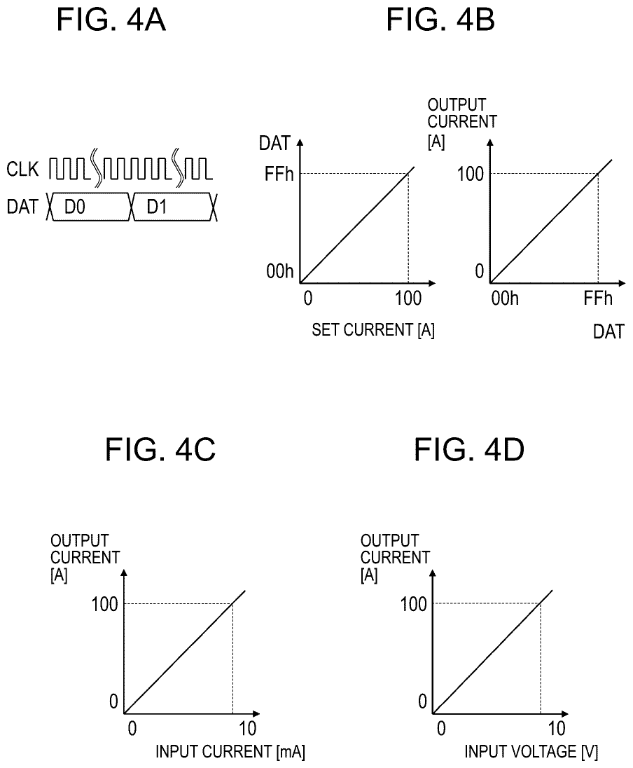

FIGS. 4A to 4D are diagrams for describing a data structure related to electrical information. The electrical information is information for designating power (current in this case) to be output from pulse power source 104 to DDL oscillator 105.

FIGS. 4A and 4B illustrate an example of a data structure in a case where digital data is used as an input to pulse power source 104. FIGS. 4C and 4D illustrate an example of electrical information in a case where analog data is used as an input to pulse power source 104.

When digital data is used as an input to pulse power source 104, a digital value corresponding to an output current is used as a parameter. Examples of the communication system used include a general-purpose serial transmission system (RS-232, I2C, etc.), a parallel transmission system, and the like. FIG. 4A illustrates an example of data communication using serial communication. In the example illustrated in FIG. 4A, the communication protocol includes a clock signal (CLK) and a data signal (DAT). Controller 101 supplies, to pulse signal generator 103, data signals D0 and D1 indicating a current value (hereinafter, setting current) to be output to pulse power source 104 in synchronization with the rising or falling of clock signal CLK as a part of the first control signal.

FIG. 4B illustrates a graph (left graph) illustrating the correspondence between the setting current and the data signal and a graph (right graph) illustrating the correspondence between the data signal and the output current. For example, when the setting current is 100 [A], in the example of the left graph of FIG. 4B, the value of data signal DAT is FF in hexadecimal. In this case, the value FF is input to data signal D0 illustrated in FIG. 4A. Pulse power source 104 that has received the first control signal including the data signal sets the output current to 100 A based on value FF of the received data signal with reference to the right graph of FIG. 4B.

FIG. 4C illustrates an example of a data structure from controller 101 to pulse power source 104 in a case where a current is used as analog data. Such a data structure is used, for example, in a case where pulse power source 104 is set to output an output current that is a predetermined multiple of the input current. In the example illustrated in FIG. 4C, pulse power source 104 outputs an output current that is 10,000 times the input current. In this case, when the first control signal having a current of 10 [mA] as the first control signal is input from controller 101 to pulse power source 104 via pulse signal generator 103, pulse power source 104 multiplies this by 10,000 and outputs a current of 100 [A].

FIG. 4D illustrates an example of a data structure from controller 101 to pulse power source 104 in a case where a voltage is used as analog data. Such a data structure is used, for example, when pulse power source 104 is set to output the corresponding output current with respect to the input voltage. In the example illustrated in FIG. 4D, when a first control signal having a voltage of 10 [V] as a first control signal is input from controller 101 to pulse power source 104 via pulse signal generator 103, pulse power source 104 outputs a current of 100 [A] corresponding thereto.

In this manner, controller 101 supplies the first control signal for outputting the pulse laser light having the power supply period and the power non-supply period as illustrated in part (b) of FIG. 2 to pulse power source 104 via pulse signal generator 103 on the basis of the time information and the electrical information. Specifically, controller 101 supplies, to pulse signal generator 103, the information specifying the ON time or OFF time of the power supply to pulse power source 104 (information corresponding to the “pulse signal” illustrated in FIGS. 3B to 3D) based on the time information, and the information indicating the relationship between the time and the power (current in the present exemplary embodiment) supplied from pulse power source 104 to DDL oscillator 105 based on the electrical information (information illustrated in FIGS. 4A to 4C) as the first control signal. Pulse signal generator 103 controls the power supplied from pulse power source 104 to DDL oscillator 105 on the basis of the first control signal, so that the pulse laser light having a desired waveform having a power supply period and a power non-supply period can be output from DDL oscillator 105.

In addition, controller 101 supplies a second control signal for irradiating target object O1 with a pulse laser group having a plurality of first periods as illustrated in part (e) of FIG. 2 to optical modulator 106 via pulse width signal generator 107 on the basis of the time information. Specifically, controller 101 supplies information designating the start time and the end time of the plurality of first periods for optical modulator 106 (information corresponding to the “pulse width signal” illustrated in FIGS. 3B to 3D) to pulse width signal generator 107 as second control information. Pulse width signal generator 107 controls switching of the emission direction of the laser light by optical modulator 106 on the basis of the second control signal, so that target object O1 can be irradiated with a pulse laser group having a desired waveform having a plurality of first periods in one power supply period.

Note that, in the above-described exemplary embodiment, pulse signal generator 103 controls pulse power source 104 on the basis of the first control signal supplied by controller 101, but the present disclosure is not limited thereto, and for example, the controller may directly supply the first control signal to the pulse power source. Similarly, in the above-described exemplary embodiment, pulse width signal generator 107 controls optical modulator 106 on the basis of the second control signal supplied by controller 101, but the present disclosure is not limited thereto. For example, the optical modulator may have a drive unit, and the controller may directly supply the second control signal to the drive unit.

### Second Exemplary Embodiment

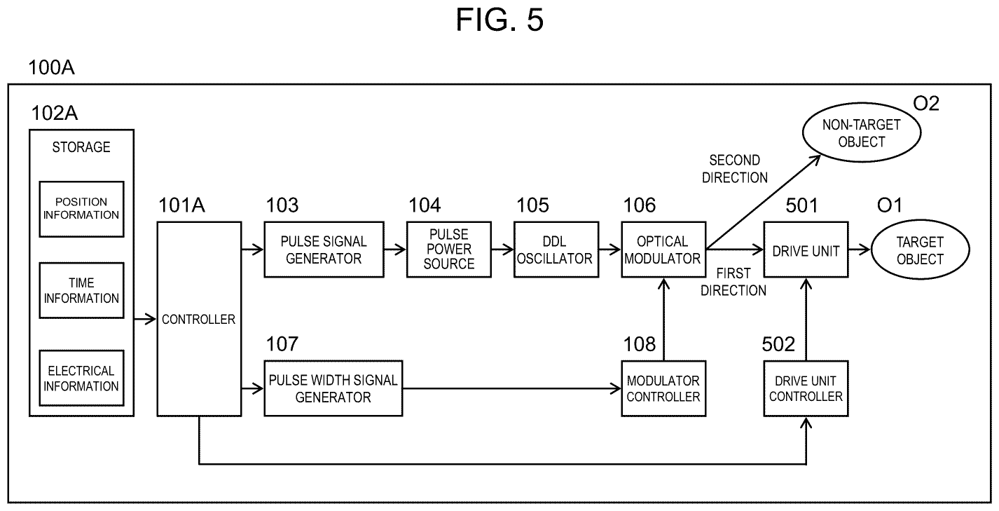

FIG. 5 is a block configuration diagram schematically illustrating laser processing device 100A according to a second exemplary embodiment of the present disclosure. In FIG. 5, the same components as those described in FIG. 1 are denoted by the same reference numerals, and description thereof is omitted. In addition to the components of the first exemplary embodiment illustrated in FIG. 1, laser processing device 100A includes drive unit 501 that changes the irradiation position of the pulse laser light emitted from optical modulator 106 on the basis of position information regarding the processing portion of target object O1, and drive unit controller 502 that controls drive unit 501.

In the second exemplary embodiment, as illustrated in FIG. 5, storage 102A stores position information regarding a processing portion of target object O1 in addition to time information and electrical information. Then, controller 101A outputs a third control signal for controlling drive unit 501 based on the position information to drive unit controller 502.

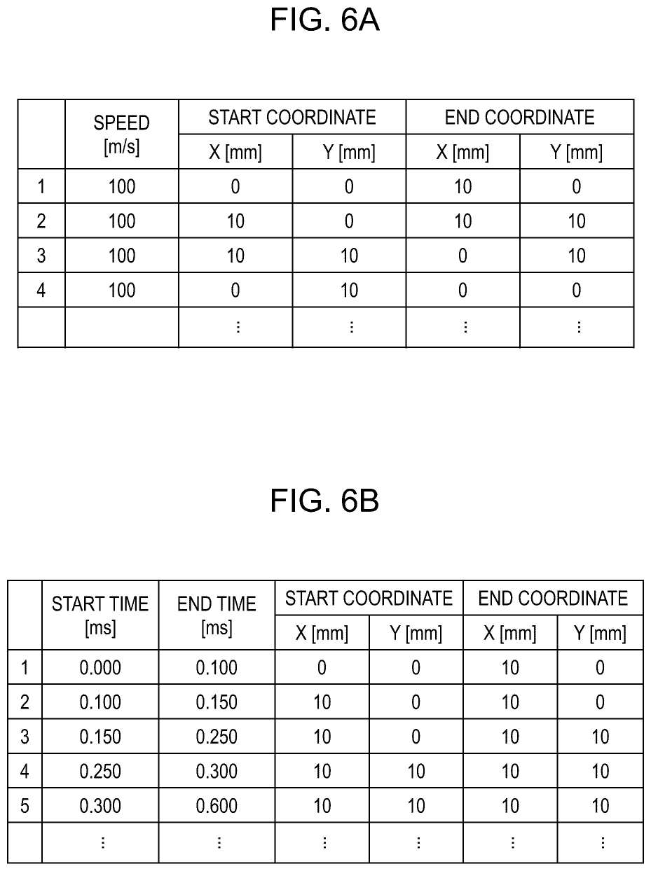

FIGS. 6A to 6B are diagrams illustrating an example of a data structure related to position information. FIG. 6A illustrates an example of the position information including the coordinate position information of the processing start position and the processing end position and the processing speed in the XY plane set as the processing target surface of target object O1. Controller 101A supplies a third control signal necessary for operating drive unit controller 502 to drive unit controller 502 on the basis of the position information. Drive unit controller 502 operates drive unit 501 on the basis of the third control signal received from controller 101A. Drive unit 501 polarizes the pulse laser light input from optical modulator 106 and moves the position of the laser light with which target object O1 is irradiated.

FIG. 6B illustrates an example of the position information in a case where the position information does not include the information related to the processing speed. Since the position information illustrated in FIG. 6B has a data structure similar to the data structure related to the time information illustrated in FIG. 3B, for example, cooperation between the third control signal, the first control signal, and the second control signal is facilitated.

In this manner, drive unit 501 can easily change the processing portion of target object O1 irradiated with the pulse laser light from optical modulator 106 using the position information, so that the processing accuracy of target object O1 can be further improved. Specifically laser processing device 100A can perform processing while moving the processing portion during or after irradiating the processing portion of target object O1 with the optical energy by the pulse laser group. Even in this case, similarly to laser processing device 100 of the first exemplary embodiment, the power supply to pulse power source 104 is turned off in the power non-supply period, so that the energy saving effect can be obtained, and optical modulator 106 emits the laser group including the plurality of first periods in one power supply period, so that target object O1 can be precisely processed.

Note that a specific example of drive unit 501 and drive unit controller 502 is a galvano scanner. The galvano scanner generally includes a galvano mirror that reflects input optical energy, a galvano motor (corresponding to drive unit 501) that drives the galvano mirror, and a control driver (corresponding to drive unit controller 502) that controls the galvano motor. The pulse laser light emitted from optical modulator 106 is irradiated to the processing portion of target object O1 via the galvano mirror. When the galvano motor is operated by the control driver, the reflection angle of the galvano mirror connected to the galvano motor is changed, so that the processing position can be controlled. In the control of the galvano motor, not only the XY plane of the processing target surface of target object O1 but also the control in the Z-axis direction perpendicular to the processing target surface may be added, and the XY plane, the XZ plane, and the YZ plane may be irradiated with the pulse laser light. In this case, the processing portion of target object O1 can be three-dimensionally processed.

### First Modification

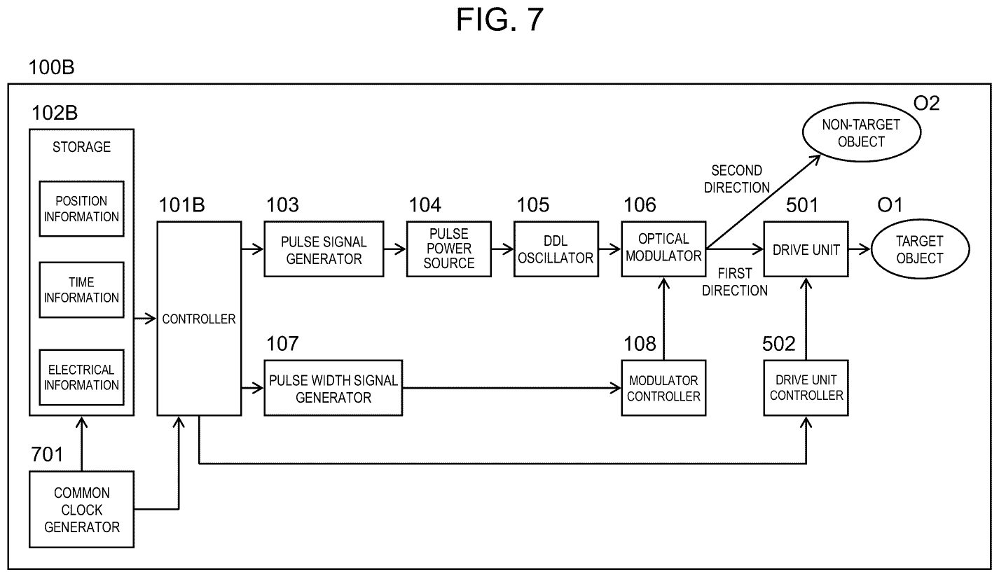

FIG. 7 is a block configuration diagram schematically illustrating laser processing device 100B obtained by modifying laser processing device 100A described in the second exemplary embodiment. Laser processing device 100B of the present first modification includes common clock generator 701, and the position information, the time information, and the electrical information read from storage 102B to controller 101B are synchronized by the clock output of common clock generator 701. As a result, the first control signal and the second control signal generated by controller 101B on the basis of the time information and the electrical information, and the third control signal generated on the basis of the position information are also synchronized by the clock output of common clock generator 701.

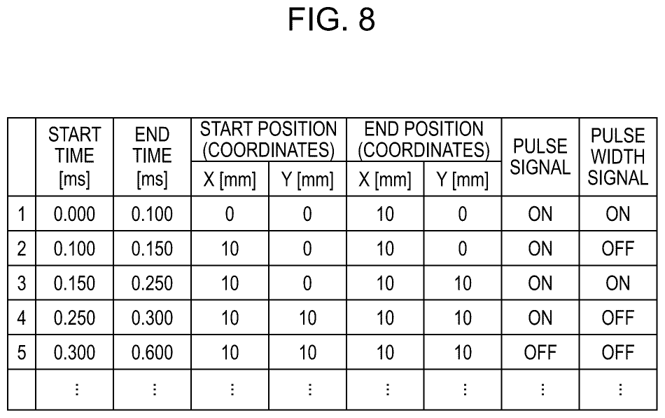

FIG. 8 is a diagram illustrating an example of a data structure holding position information and time information used in laser processing device 100B of FIG. 7. In this data structure, the processing start position, the processing end position, and the ON/OFF information of the pulse signal and the pulse width signal are associated with each other using the start time and the end time by the common clock as parameters.

According to such a configuration of the first modification, since controller 101B operates on the basis of the common clock, cooperation among the time information, the electrical information, and the position information, and furthermore, cooperation among the first control signal, the second control signal, and the third control signal are facilitated. Based on the data structure illustrated in FIG. 8, controller 101B generates the first control signal, the second control signal, and the third control signal on the basis of the common clock, so that it is possible to prevent deterioration in processing quality due to timing deviation or the like due to asynchronization of the clock signals.

### Second Modification

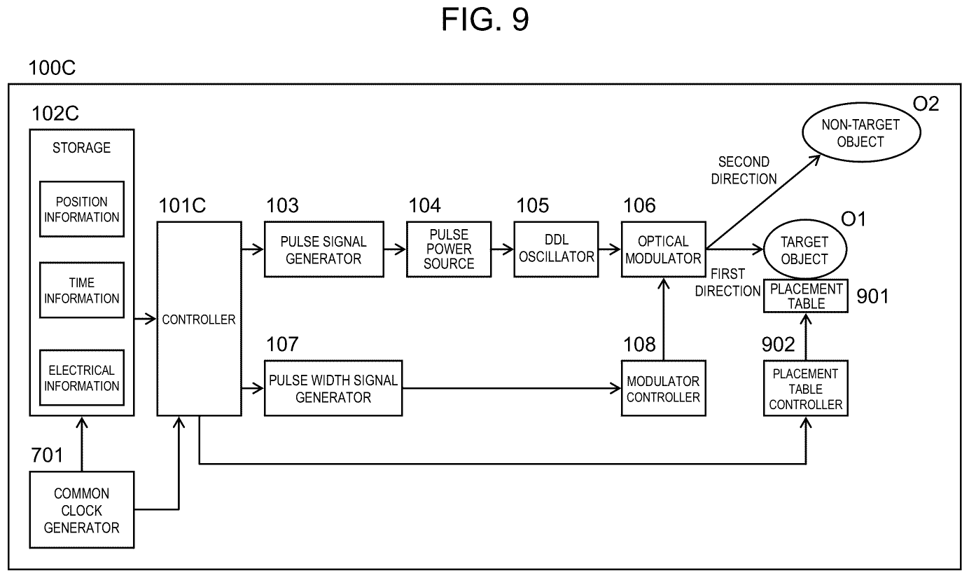

FIG. 9 is a block configuration diagram schematically illustrating laser processing device 100C obtained by further modifying laser processing device 100B according to the first modification of the second exemplary embodiment. In the second exemplary embodiment, the irradiation position of the laser light emitted from optical modulator 106 is changed by drive unit 501, but in the present second modification, target object O1 is moved by the movement of placement table 901 on which target object O1 is placed, and the irradiation position of the laser light is changed. Placement table 901 is moved by placement table controller 902 based on the third control signal supplied by controller 101C. Controller 101C may generate the third control signal on the basis of the position information stored in advance in storage 102C.

According to the configuration of the present second modification, when placement table 901 is moved, for example, along a horizontal plane, the processing place of target object O1 fixed to placement table 901 is suitably irradiated with the laser light emitted from optical modulator 106. While drive unit 501 and drive unit controller 502 in the second exemplary embodiment need to have a complicated structure interlocked mechanically and optically, in the present second modification, placement table 901 and placement table controller 902 that simply move mechanically only need a simple structure, so that the manufacturing cost of laser processing device 100C can be reduced.

### Action, Effect

As described above, according to the laser processing device of the present disclosure, it is possible to achieve both high quality processing and reduction in power consumption. Specifically, in the laser processing device according to the present disclosure, a power supply period for supplying power to the DDL oscillator and a power non-supply period for not supplying power are provided. As a result, as compared with a case where power is constantly supplied to the DDL oscillator, power consumption at the time of laser processing of a target object can be greatly reduced.

Furthermore, in the laser processing device according to the present disclosure, the irradiation destination of the laser light emitted from the DDL oscillator is switched at high speed using the optical modulator such that a plurality of first periods in which the target object is irradiated with the pulse laser light and a plurality of other periods in which the target object is not irradiated are included in one power supply period. As a result, the energy amount of the laser light with which the target object is irradiated can be precisely controlled.

In the laser processing device according to the present disclosure, the energy amount of the laser light with which the target object is irradiated is controlled by adjusting the length of the first period. Specifically, the optical energy control in which the amount of optical energy applied to the processing portion is relatively increased immediately after the processing of target object O1 is started, and the amount of optical energy is gradually decreased toward the final stage of the processing is realized by gradually shortening the length of the first period from t1 to t3 as illustrated in part (e) of FIG. 2. As a result, in the laser processing device according to the present disclosure, since it is not necessary to control the output amplitude of the pulse laser light by the DDL oscillator in order to adjust the amount of optical energy of the laser light with respect to the target object, it is not necessary to have a function of controlling the output amplitude, and the manufacturing cost of the laser processing device can be reduced accordingly.

### REFERENCE MARKS IN THE DRAWINGS

100, 100A, 100B, 100C: laser processing device
101, 101A, 101B, 101C: controller
102, 102A, 102B, 102C: storage
103: pulse signal generator
104: pulse power source
105: DDL oscillator
106: optical modulator
107: pulse width signal generator
108: modulator controller
501: drive unit
502: drive unit controller
701: common clock generator
901: placement table
902: placement table controller

1. A laser processing device, comprising:
a laser oscillator that oscillates pulse laser light;
a power source that supplies power to the laser oscillator;
an optical modulator that switches an emission direction of the pulse laser light to either a first direction toward a target object or a second direction not toward the target object; and
a controller that generates a first control signal and a second control signal,
the first control signal being a signal for controlling supply of the power by the power source to generate at least one set of a power supply period and a power non-supply period,
the second control signal being a signal for controlling change of the emission direction by the optical modulator to cause the power supply period to include a plurality of first periods in which the emission direction is the first direction.

2. The laser processing device according to claim 1, wherein
the controller generates the second control signal to cause the plurality of first periods to have a plurality of temporal lengths in the power supply period.

3. The laser processing device according to claim 2, wherein
the controller generates the second control signal to cause a last one of the plurality of first periods to have a shorter temporal length than a first one of the plurality of first periods in the power supply period.

4. The laser processing device according to claim 1, wherein
the controller generates the first control signal to cause an amplitude of the pulse laser light to be oscillated by the laser oscillator to be a constant value in the power supply period.

5. A control method of a laser processing device that includes:
a power source that supplies power to a laser oscillator that oscillates pulse laser light;
an optical modulator that switches an emission direction of the pulse laser light to either a first direction toward a target object or a second direction not toward the target object; and
a controller that generates a control signal for the power source and the optical modulator, the control method comprising:
generating, by the controller, a first control signal for controlling supply of the power to generate at least one set of a power supply period and a power non-supply period, and outputting the first control signal to the power source; and
generating, by the controller, a second control signal for controlling change of the emission direction to cause the power supply period to include a plurality of first periods in which the emission direction is the first direction, and outputting the second control signal to the optical modulator.

6. A program executed by a computer of a laser processing device that includes:
a power source that supplies power to a laser oscillator that oscillates pulse laser light;
an optical modulator that switches an emission direction of the pulse laser light to either a first direction toward a target object or a second direction not toward the target object; and
a controller that generates a control signal for the power source and the optical modulator, the program causing the computer to execute procedures of:
generating a first control signal for controlling supply of the power to generate at least one set of a power supply period and a power non-supply period, and outputting the first control signal to the power source; and
generating a second control signal for controlling change of the emission direction to cause the power supply period to include a plurality of first periods in which the emission direction is the first direction, and outputting the second control signal to the optical modulator.

7. A laser processing device, comprising:
a laser oscillator that emits pulse laser light;
an optical modulator that irradiates a target object with a pulse laser group including a plurality of sub-pulse light beams shorter than one pulse of the pulse laser light by switching an emission direction of the pulse laser light; and
a controller that controls outputting of the pulse laser light by the laser oscillator and switching of the emission direction by the optical modulator.
